(19) United States
(12) Patent Application Publication
(10) Pub. No.: US 2021/0069917 A1
(43) Pub. Date: Mar. 11, 2021

(54) GRIPPERS TO PICK PLASTIC SLEEVED CUPS FOR CASE CARTONING USING INDUSTRIAL AND COLLABORATIVE ROBOTS

(71) Applicants: Brian Charles Cloetingh, Dowingtown, PA (US); Brian Denny, Dowingtown, PA (US)

(72) Inventors: Brian Charles Cloetingh, Dowingtown, PA (US); Brian Denny, Dowingtown, PA (US)

(21) Appl. No.: 17/017,377

(22) Filed: Sep. 10, 2020

Related U.S. Application Data
(60) Provisional application No. 62/898,377, filed on Sep. 10, 2019.

(51) Int. Cl. B25J 15/10; B25J 13/06; B25J 9/14

(52) U.S. Cl. CPC B25J 15/10; B25J 9/14; B25J 13/06

(57) ABSTRACT

Devices, systems and methods for reliably picking up and controlling a cup stack sealed in a bag or sleeve are disclosed. A gripper comprising a plurality of fingers is mounted to one end of a robotic arm. The gripper may comprise a first component mounted on a first finger of the plurality of fingers and a second component mounted on a second finger of the plurality of fingers. The first component may be cone-shaped and the second component may comprise a paddle that is curved to accommodate a cup stack. The first component and the second component may grip a plastic sleeved cup stack. The robotic arm may push the plastic sleeved cup stack against a guiderail to compress the cup stack. Compressing the cup stack may allow for reliable transport and placement into a shipping box. The disclosed devices, systems and methods may be fully or partially automated.

### CROSS REFERENCE TO RELATED APPLICATION

This application claims the benefit of U.S. Provisional Application No. 62/898,377, filed on Sep. 10, 2019, which is incorporated by reference as if fully set forth.

### FIELD OF INVENTION

This invention relates generally an automated system and methods. More particularly, this invention relates to a gripper mechanism for industrial and collaborative robots.

### BACKGROUND

A robotic mechanism may be used to pick up and control a cup stack that has been previously sealed in a bag or sleeve. The robotic mechanism may be configured to place the cup stack into a shipping box or carton. However, if the cup stack is not compressed, the cup stack may sag, making accurate placement or positioning difficult or impossible. Currently, these operations are done manually. An automated process for cup stack handling and case packing would be efficient and cost effective.

### SUMMARY

Devices, systems and methods for reliably picking up and controlling a cup stack sealed in a bag or sleeve are disclosed. A gripper comprising a plurality of fingers is mounted to one end of a robotic arm. The gripper may comprise a first component mounted on a first finger of the plurality of fingers and a second component mounted on a second finger of the plurality of fingers. The first component may be cone-shaped and the second component may comprise a paddle that is curved to accommodate a cup stack. The first component and the second component may grip a plastic sleeved cup stack. The robotic arm may push the plastic sleeved cup stack against a guiderail to compress the cup stack. Compressing the cup stack may allow for reliable transport and placement into a shipping box. The disclosed devices, systems and methods may be fully or partially automated.

### BRIEF DESCRIPTION OF THE DRAWINGS

FIGS. 1A and 1B are perspective views of a robotic arm with a gripper, according to an embodiment;

FIG. 2A is a perspective view and FIG. 2B is a side view of a single stack gripper, according to an embodiment;

FIGS. 3A and 3B are perspective views of a quad stack gripper, according to an embodiment; and

FIG. 4 is a flow diagram illustrating a method of manipulating a cup stack, according to an embodiment.

### DETAILED DESCRIPTION OF THE PREFERRED EMBODIMENTS

Systems, devices and methods for reliably picking up and controlling a cup stack sealed in a bag or sleeve are disclosed. The disclosed methods, devices and systems may be used in conjunction with an industrial and collaborative robots. The disclosed systems, devices and methods may be fully automated to reduce or eliminate the need for human intervention.

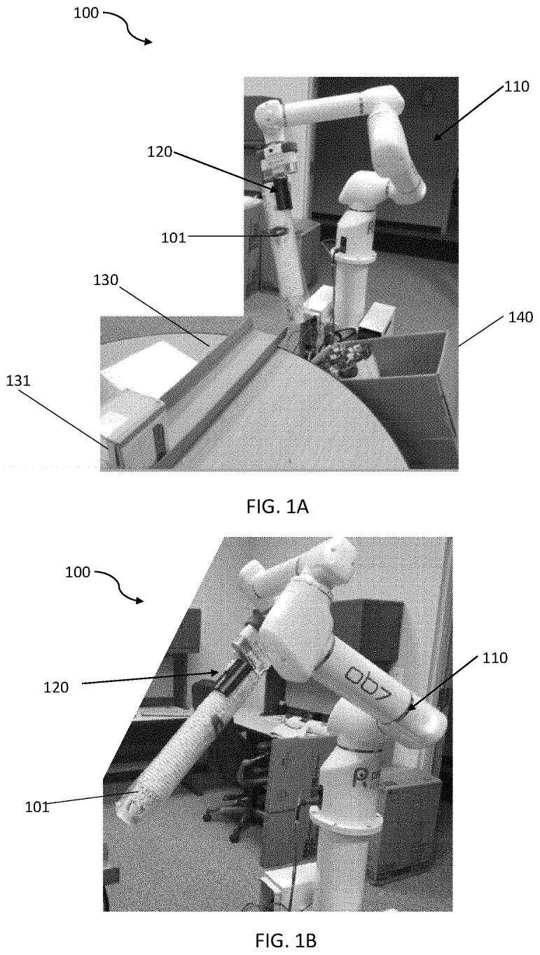

With reference to FIGS. 1A and 1B, during a packaging process, a cup stack may be sealed in a plastic bag or sleeve. After sealing, the plastic sleeved cup stack 101 may be placed on a conveyer belt 130 for packaging. A robotic arm 110 with an end of arm tool 120 mounted on one end may be aligned with the conveyer belt 130. The end of arm tool 120 of the robotic arm 110 may be configured to pick up one or more plastic sleeved cup stacks 101 off of the conveyer belt and place the one or more plastic sleeve cup stacks 101 into a shipping container 140. The structure, operation, programming, and control of the robotic arm are well known in the art, and therefore will not be described in detail herein. The mechanisms of the end of arm tool 120, such as a gripper, may be pneumatically actuated by electrically operated pneumatic solenoids. The robotic arm 110 may provide the necessary electrical and pneumatic connections for the end of arm tool 120. When actuated, the end of arm tool 120 may move from an open position to a closed position, and vice-versa. As used herein, the terms “end of arm tool” and “gripper” are used interchangeably.

The end of arm tool 120 may work in conjunction with a guiderail 131 to compress the plastic sleeved cup stack. The guiderail 131 may be located on a side of the conveyer belt 130 that is opposite the robotic arm 110. The robotic arm 110 may move in such a way as to push the plastic sleeved cup stack 101 against the guiderail to compress the cup stack 101. By compressing the cup stack 101, the robotic arm 110 may reliably and accurately place the plastic sleeved cup stack into a shipping container 140.

A controller (not shown) may send control signals which timely activate motors of the robotic arm 110 to perform various action sequences. The controller may also send control signals which activate one or more actuators of the end of arm tool 120 so as to cause the tool to move from an open position to a closed position, and vice-versa.

A graphical user interface (GUI) (not shown) may be provided to for allowing an operator to control the motorized operations of the robotic arm 110 and/or end of arm tool 120. Additionally or alternatively, the graphical user interface may display information regarding the current state of the robotic arm and/or end of arm tool.

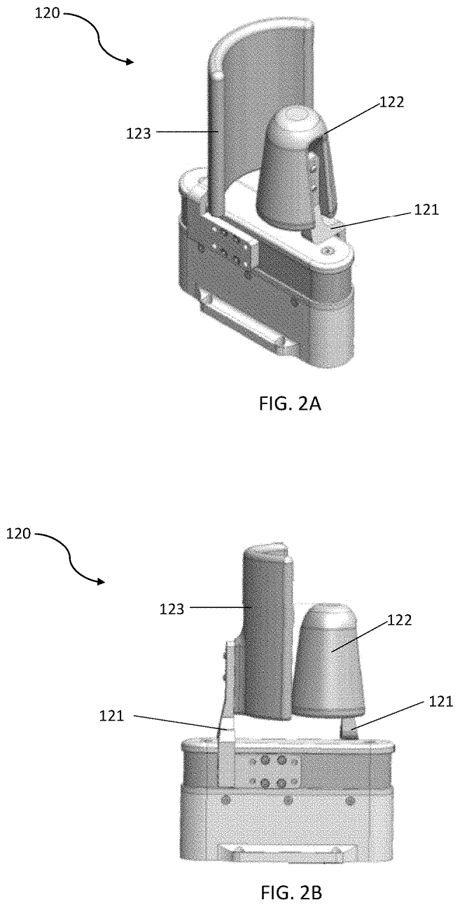

With reference to FIGS. 2A and 2B, an end of arm tool 120 in accordance with the present disclosure is illustrated. The end of arm tool 120 may comprise a gripper mounted on one end of a robotic arm. The gripper may comprise a plurality of fingers 121. In some embodiments, the gripper is a parallel jaw gripper.

A cone-shaped component 122 that is cone-shaped may be mounted onto one finger of the plurality of fingers 121. The wide side of the cone-shaped component 122 may be adjacent to the robotic arm. A paddle component 123 may be mounted onto a different finger of the plurality of fingers 121. The paddle component 123 may be slightly curved to accommodate the cup stack. Together, the cone-shaped component 122 and the paddle component 123 act together to grip the cup stack. The cone-shaped component 122 of the gripper may put enough tension on a plastic sleeved cup stack so that it compresses the cup stack, but not so much that it breaks the plastic. The gripper illustrated in FIGS. 2A and 2B may be configured to grip a single plastic sleeved cup stack.

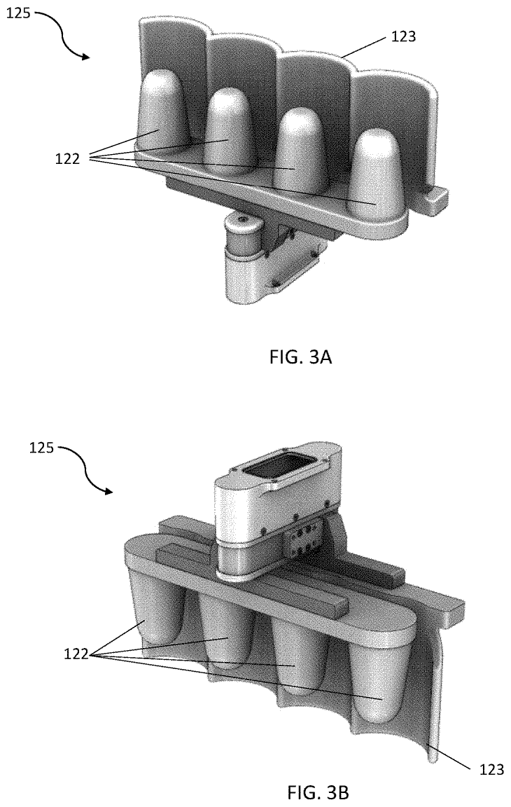

With reference to FIGS. 3A and 3B, in some embodiments, the gripper may comprise a plurality cone-shaped components 122 and the paddle component 123 may comprise multiple curves which align with each of the plurality of cone shaped components 122. Alternatively, there may be a plurality of separate paddle components 123 (not shown) which align with each of the plurality of cone-shaped components. This enables the gripper to grip and manipulate a plurality of plastic sleeved cup stacks at the same time. In the embodiment illustrated in FIGS. 3A and 3B, a quad stack gripper 125 comprising four cone-shaped components 122 and a single paddle component 123 comprising four curves which align with each of the plurality of cone-shaped components 122 is illustrated. The quad gripper 125 may be capable of gripping four separate plastic sleeved cup stacks and/or four cup stacks sealed in the same plastic sleeve at one time. The quad gripper 125 may allow for even better efficiency and accuracy during the packing process.

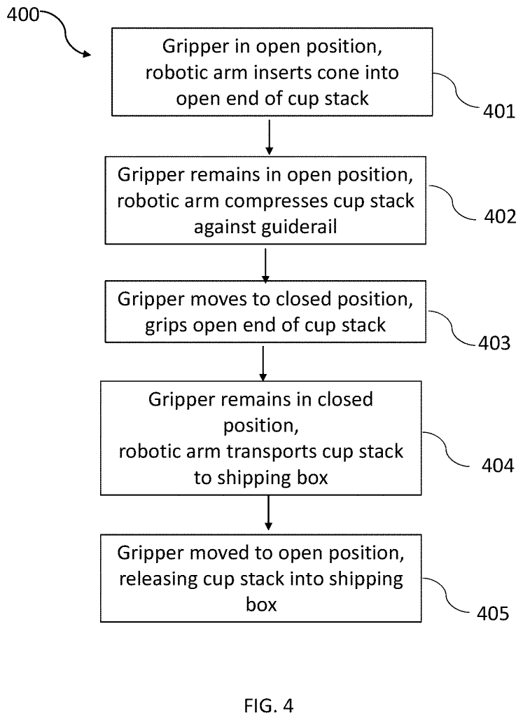

With reference to FIG. 4, a flow diagram illustrating a method of manipulating a cup stack 400 in accordance with the present disclosure is shown. At 401, the gripper is in an open position and control signals activate mechanisms causing the robotic arm to move such that the cone of the gripper an open end of a plastic sleeved cup stack. At 402, while the gripper is in an open position, the robotic arm receives control signals causing the robotic arm to push the plastic sleeve cup stack against the guiderail to compress the cups. At 403, control signals activate one or more actuators of the gripper which cause the gripper to close. The gripper may grip the plastic sleeve cup stack when in a closed position. At 404, the robotic arm may then transport the cup stack to a shipping box or carton. At 405, once the plastic sleeve cup stack is in the desired position, the gripper may return to an open position, releasing the cup stack into the shipping box or carton. The foregoing method 400 may be performed using the systems and devices disclosed above. For example, method 400 may be performed using the quad stack gripper 125 illustrated in FIGS. 3A and 3B and may comprise manipulating up to four plastic sleeved cup stacks at one time.

What is claimed is:

1. A system comprising:
a robotic arm comprising a gripper, the gripper comprising a plurality of fingers;
a first component mounted on a first finger of the plurality of fingers;
a second component mounted on a second finger of the plurality of fingers, wherein the first component and the second component are configured to grip a plastic sleeved cup stack; and
a guiderail.

2. The system of claim 1, wherein the first component is cone-shaped.

3. The system of claim 1, wherein the second component is a paddle.

4. The system of claim 3, wherein the paddle is slightly curved to accommodate the plastic sleeved cup stack.

5. The system of claim 1, comprising a plurality of first components mounted on separate fingers of the plurality of fingers.

6. The system of claim 5, wherein the second component comprises multiple curves to accommodate multiple plastic sleeved cup stacks.

7. The system of claim 1, comprising four first components and wherein the second component comprises four curves to accommodate four plastic sleeved cup stacks.

8. The system of claim 1, further comprising a graphical user interface (GUI).

9. The system of claim 1, wherein the guiderail is located opposite the robotic arm.

10. The system of claim 1, wherein the first finger and the second finger comprise a parallel jaw gripper.

11. The system of claim 1, wherein the plurality of fingers each comprise a pneumatic actuator.

12. A method comprising:
inserting a first component mounted on one finger of a plurality of finger of a gripper into an open end of a plastic sleeved cup stack, wherein the gripper is mounted on one end of a robotic arm and is in an open position, and a second component surrounds the plastic sleeved cup stack;
activating one or more actuators of the gripper causing the gripper to be a closed position, wherein the first component and the second component grip the plastic sleeved cup stack;
activating mechanisms of the robotic arm to compress the plastic sleeved cup stack against a guiderail;
activating mechanisms of the robotic arm to transport the plastic sleeved cup stack to a shipping box; and
activating the one or more actuators of the gripper to cause the gripper to be in an open position, wherein the plastic sleeved cup stack is released into the shipping box.

13. The method of claim 12, wherein the first component is cone-shaped.

14. The method of claim 13, wherein the first component creates tension on the plastic of the plastic sleeved cup stack.

15. The method of claim 12, wherein the second component is a paddle.

16. The method of claim 15, wherein the paddle is slightly curved to accommodate the plastic sleeved cup stack.

17. The method of claim 12, wherein a plurality of first components are mounted on different fingers of the plurality of fingers.

18. The method of claim 17, wherein the second component comprises multiple curves to accommodate a plurality of plastic sleeved cup stacks.

19. The method of claim 18, wherein the plastic sleeved cup stack comprises a plurality of plastic sleeved cup stacks.

20. The method of claim 12, further comprising displaying information on a graphical user interface (GUI).
